(19) United States
(12) Patent Application Publication
(10) Pub. No.: US 2012/0098930 A1
(43) Pub. Date: Apr. 26, 2012

(54) IMAGE PROCESSING DEVICE, IMAGE PROCESSING METHOD, AND PROGRAM

(75) Inventor: Tadashi YAMAGUCHI, Saitama (JP)

(73) Assignee: Sony Corporation, Tokyo (JP)

(21) Appl. No.: 13/235,835

(22) Filed: Sep. 19, 2011

(30) Foreign Application Priority Data
Oct. 22, 2010 (JP) 2010-237883

(51) Int. Cl. H04N 13/00

(52) U.S. Cl. 348/43; 348/E13.002; 348/E13.026

(57) ABSTRACT

An image processing device including a video signal output section which executes resolution conversion of an image, where in a case where a plurality of different images are included in an input image which is the resolution conversion target, the video signal output section executes a reference pixel setting process, which is the same as a reference pixel setting process of an image edge portion, at the time of a pixel value calculation of an output image in the vicinity of the image boundary, and a pixel value of an output pixel in the vicinity of the image boundary is determined using a pixel value of a reference pixel set using the image edge process.

### BACKGROUND

The present disclosure relates to an image processing device, an image processing method, and a program. In detail, the disclosure relates to an image processing device, an image processing method, and a program which execute a correction process with regard to, for example, an image which includes a plurality of different images such as a left-eye image and a right-eye image which configure a three dimensional image (3D image).

In the past, display devices such as televisions, PCs, and the like which are able to display three dimensional images (3D images), and video cameras, still cameras, and the like which are able to record three dimensional images (3D images) have been developed and used. A display process is performed where 3D images use images captured from different viewpoints, that is, left-eye images and right-eye images. Accordingly, in a case where three dimensional images are recorded on a medium, it is necessary to record the left-eye image and the right-eye image as one set of images and reproduction is performed using the sets of images at the time of the reproduction process.

There are various methods for the processing methods of the recording and transmitting of three dimensional image data. For example, as representative methods, the methods of a frame sequential method, a side by side method and a top and bottom method are known.

The frame sequential method is a method where frames of the left-eye image (L image) and the right-eye image (R image) are recorded and transmitted alternately as L, R, L, R, . . . .

The side by side method is a method where the LR images are partitioned into left and right in one frame image and recorded and transmitted.

The top and bottom method is a method where the LR images are partitioned into top and bottom in one frame image and recorded and transmitted.

Out of the methods above, in the side by side method and the top and bottom method, the L image and the R image are contained in partition regions (side by side or top and bottom) set in one image frame and are transmitted. A process is performed in a display device where, for example, the transmitted data is received, the L image and the R image are obtained from one frame image, and the LR images are output alternately.

Here, for example, it is often the case that the resolution of 3D images, which are captured by an imaging device such as a video camera and recorded in a medium such as a HD, and the resolution of the display device are typically different from each other. Accordingly, at the time of the display process of the 3D images recorded on the medium using the imaging device, an image correction process is performed where the 3D images are enlarged or reduced according to the resolution of the display device.

In the image correction process, an interpolation process or the like is performed where, for example, a pixel value of a constituent pixel of an input image is referenced when determining in a pixel value of a pixel in an output image. As the technique for a pixel value interpolation process, it is possible to use an interpolation process known from the past such as a linear interpolation process, a bilinear process, or a bi-cubic process.

However, in the side by side method and the top and bottom method described above, the LR images are set in partition regions (side by side or top and bottom) in one image frame and are transmitted as described above. In regard to such an image, there is a problem in the interpolation process of a boundary portion of the LR images when an interpolation process is executed when a peripheral pixel is the reference pixel.

For example, in a case where the interpolation process of the L image is performed in the vicinity of the boundary of the L image and the R image, there is a phenomenon where the pixel value of the R image which is adjoined to the L image is referenced. In the same manner, also in regard to the R image, there is a phenomenon where the pixel value of the L image, which is adjoined to the R image in the vicinity of the boundary of the LR images, is referenced and an interpolation pixel value is determined. When interpolation is performed based on an erroneous reference process such as this, there is a problem in that, fundamentally, a pixel value is set which is significantly different from the pixel value which to be set, and a pixel which includes noise is output.

In this manner, when image correction is executed such as enlargement or reduction with regard to images where a plurality of images are arranged in the same frame image such as the side by side method and the top and bottom method described above, there is influence from a pixel of another image when correcting in the vicinity of the boundary of the left-eye image and the right-eye image.

As techniques in the related art which propose a technique to solve such a problem, there is, for example, Japanese Unexamined Patent Application Publication No. 2008-236526. Japanese Unexamined Patent Application Publication No. 2008-236526 discloses a configuration where detection of an edge pattern included in an image is performed and interpolation processing methods are switched according to the detected edge pattern.

However, even if the technique is applied, there are still cases where a peripheral pixel is used as the reference pixel when interpolating and it is not possible to perform processing such that the left-eye image and the right-eye image are reliably distinguished.

Furthermore, Japanese Unexamined Patent Application Publication No. 7-79418 discloses a configuration where accurate resolution conversion is performed by using a pixel in a time direction.

However, even in this technique, a peripheral pixel is used as the reference pixel and it is not possible to completely prevent the reference process between different images in regard to pixels in the vicinity of the boundary of the left-eye image and the right-eye image.

In this manner, there are the problems described below as the problems in the related art.

Since there is influence from the opposite eye image in the vicinity of the boundary of the left-eye image and the right-eye image when enlarging or reducing an image, there is noise on the screen in the top and bottom of the screen in the case of an image of the top and bottom method and in the left and right of the screen in the case of an image of the side by side method. As a result, there is deterioration in image quality of the 3D images which use the images after correction processing and accuracy also decreases with regard to image analysis functions which use 3D images.

### SUMMARY

It is desirable to provide an image processing device, an image processing method, and a program are proposed where it is possible to prevent an erroneous correction process in a image boundary portion such as a boundary of LR images and generate a high-quality image with a configuration where a correction process is executed with regard to, for example, an image which includes a plurality of different images such as a left-eye image (L image) and a right-eye image (R image) which configure a three dimensional image (3D image).

According to a first embodiment of the disclosure, an image processing device has a video signal output section which executes resolution conversion of an image, where in a case where a plurality of different images are included in an input image which is the resolution conversion target, the video signal output section executes a reference pixel setting process using an image edge process, which is the same as a reference pixel setting process of an image edge portion, at the time of a pixel value calculation of an output image in the vicinity of the image boundary, and a pixel value of an output pixel in the vicinity of the image boundary is determined using a pixel value of a reference pixel set using the image edge process.

Furthermore, in the image processing device according to a first embodiment of the disclosure, it is desirable if the video signal output section sets a virtual pixel, which is generated using a pixel mirroring process in the image boundary portion of the input image, as the reference pixel at the time of the pixel value calculation of the output image in the vicinity of the image boundary.

Furthermore, in the image processing device according to a first embodiment of the disclosure, it is desirable if the video signal output section sets a virtual pixel, which is generated using a pixel copy process in the image boundary portion of the input image, as the reference pixel at the time of the pixel value calculation of the output image in the vicinity of the image boundary.

Furthermore, in the image processing device according to a first embodiment of the disclosure, it is desirable if the video signal output section sets a weighting coefficient according to the distance between a pixel position of the output pixel and the reference pixel and calculates the pixel value of the output pixel using the pixel value calculation of the reference pixel where the weighting coefficient has been applied at the time of the pixel value calculation of the output image in the vicinity of the image boundary.

Furthermore, in the image processing device according to a first embodiment of the disclosure, it is desirable if the video signal output section has a horizontal direction resolution conversion section which executes the setting of the pixel value of the output pixel using the image edge process at the time of the pixel value calculation of the output image in the vicinity of the image boundary in the horizontal direction of the image and a vertical direction resolution conversion section which executes the setting of the pixel value of the output pixel using the image edge process at the time of the pixel value calculation of the output image in the vicinity of the image boundary in the vertical direction of the image.

Furthermore, in the image processing device according to a first embodiment of the disclosure, it is desirable if the video signal output section executes determination of whether or not there is a pixel in the vicinity of the image boundary section where it is necessary to execute the image edge process based on phase information which shows each pixel position in the output image.

Furthermore, in the image processing device according to a first embodiment of the disclosure, it is desirable if the video signal output section executes the image edge process in the setting process of the reference pixel which is applied to the pixel value calculation of the output image in the vicinity of the image boundary of a left-eye image and a right-eye image at the time of the resolution conversion process with regard to an image with side by side format and an image with top and bottom format which are applied to three dimensional image display.

Furthermore, in the image processing device according to a first embodiment of the disclosure, it is desirable if the video signal output section executes the resolution conversion in parallel with regard to a plurality of different pixel signals.

Furthermore, in the image processing device according to a first embodiment of the disclosure, it is desirable if the plurality of different pixel signals are each -signal of an YCbCr signal.

Furthermore, in the image processing device according to a first embodiment of the disclosure, it is desirable if the video signal output section executes the resolution conversion, which corresponds to a plurality display sections with different resolutions, in parallel.

An image display device according to a second embodiment of the disclosure has a video signal output section which executes resolution conversion of an image and a display section which displays a generated video signal of the video signal output section, where in a case where a plurality of different images are included in an input image which is the resolution conversion target, the video signal output section executes a reference pixel setting process using an image edge process, which is the same as a reference pixel setting process of an image edge portion, at the time of a pixel value calculation of an output image in the vicinity of the image boundary, and a pixel value of an output pixel in the vicinity of the image boundary is determined using a pixel value of a reference pixel set using the image edge process.

An image processing method according to a third embodiment executed by an image processing device, which includes a video signal output section which executes resolution conversion of an image, including executing a reference pixel setting process using an image edge process, which is the same as a reference pixel setting process of an image edge portion, at the time of a pixel value calculation of an output image in the vicinity of the image boundary, and determining a pixel value of an output pixel in the vicinity of the image boundary using a pixel value of a reference pixel set using the image edge process, using the video signal output section, in a case where a plurality of different images are included in an input image which is the resolution conversion target.

A program according to a fourth embodiment of the disclosure which executes in an image processing device, which includes a video signal output section which executes resolution conversion of an image, including making the video signal output section execute a reference pixel setting process using an image edge process, which is the same as a reference pixel setting process of an image edge portion, at the time of a pixel value calculation of an output image in the vicinity of the image boundary, and determine a pixel value of an output pixel in the vicinity of the image boundary, in a case where a plurality of different images are included in an input image which is the resolution conversion target using a pixel value of a reference pixel set using the image edge process.

Here, the program according to the embodiment of the disclosure is, for example, a program which is provided using, for example, a recording medium with regard to an information processing device or a computer system which is able to execute various programs and codes. The process according to the program is realized by having the program executed by a program execution section on the information processing device or the computer system.

Other aims, characteristics, and advantages of the disclosure will be made clear due to a more detailed description based on the embodiments of the disclosure described below and the attached diagrams. Here, the system in the disclosure is a configuration of a logical collection of a plurality of devices and is not limited to the devices of each configuration being in the same housing.

According to the embodiments of the disclosure, a configuration is realized where noise generation in an image boundary section is prevented in resolution conversion with regard to an image where a plurality of adjoining images are recorded. Specifically, in a case where, for example, a plurality of different images are included in an input image which is the resolution conversion target, a reference pixel setting process using an image edge process, which is the same as a reference pixel setting process of an image edge portion, is executed at the time of a pixel value calculation of an output image in the vicinity of the image boundary, and a pixel value of an output pixel in the vicinity of the image boundary is determined using a pixel value of a reference pixel set using the image edge process. For example, a virtual pixel, which is generated using a mirroring process or a copy process of a pixel in the image boundary portion of the input image which is the same as the output image, is set as the reference pixel, and the pixel value of the output pixel in the vicinity of the image boundary is determined. Due to the process, the pixel value of the output image in the vicinity of the image boundary portion is calculated without referencing a pixel value of an adjacent different image and generation of an output image with high image quality is possible which prevents noise generation due to influence of another image in the boundary portion.

### BRIEF DESCRIPTION OF THE DRAWINGS

FIG. 1 is a diagram describing a configuration example of an image processing device according to an embodiment of the present disclosure;

FIG. 2 is a diagram describing a multi-picture format standard;

FIG. 3 is a diagram describing an image with side by side format;

FIG. 4 is a diagram describing a resolution conversion process executed according to an output device;

FIG. 5 is a diagram describing a 3D display process based on a 3D display command and a 2D display process based on a 2D display command;

FIG. 6 is a block diagram illustrating a detailed configuration of a video signal output section;

FIG. 7 is a diagram describing a flow of a process from a pixel data partition section to a pixel data integrating section;

FIG. 8 is a block diagram illustrating a configuration example of a resolution conversion section;

FIG. 9 is a diagram illustrating a flow chart describing a sequence of a resolution conversion process executed in the resolution conversion section shown in FIG. 8;

FIG. 10 is a diagram describing corresponding pixels and a process in a case where the horizontal direction resolution of an input image is 1440 and the horizontal direction resolution after resolution conversion is 1920;

FIG. 11 is a diagram describing a detailed configuration example of a calculation pixel selecting section;

FIGS. 12A and 12B are diagrams describing example of image edge processes;

FIGS. 13A and 13B are diagrams describing noise generation in a boundary portion of an example of an image with side by side format;

FIGS. 14A to 14C are diagrams describing a specific example of an output pixel generating process in a boundary portion of LR images;

FIG. 15 is a diagram describing an example of a pixel value calculation process of an output pixel using a linear interpolation process;

FIG. 16 is a diagram describing an example of a pixel value calculation process of an output pixel using a linear interpolation process;

FIG. 17 is a diagram describing an example of a pixel value calculation process of an output pixel using a linear interpolation process;

FIG. 18 is a diagram describing an example of a pixel value calculation process of an output pixel using a linear interpolation process;

FIGS. 19A and 19B are diagrams describing noise generation in a boundary portion of an example of an image with top and bottom format;

FIG. 20 is a diagram describing an example of an image including images from multiple viewpoints in one image frame; and

FIG. 21 is a diagram describing a hardware configuration example of an image processing device according to an embodiment of the disclosure.

### DETAILED DESCRIPTION OF EMBODIMENTS

Below, details of an image processing device, an image processing method, and a program of the disclosure will be described with reference to the diagrams. The description will be performed in accordance with the items below.

1. Configuration and Processing of Image Processing Device

2. Details of Resolution Conversion Process

3. Process Example when Image has Top and Bottom Format

4. Resolution Conversion Process of Images with Multiple Viewpoints

5. Switching Process between Three Dimensional Images (3D) and Two Dimensional Images (2D)

6. Hardware Configuration Example of Image Processing Device

1. Configuration and Processing of Image Processing Device

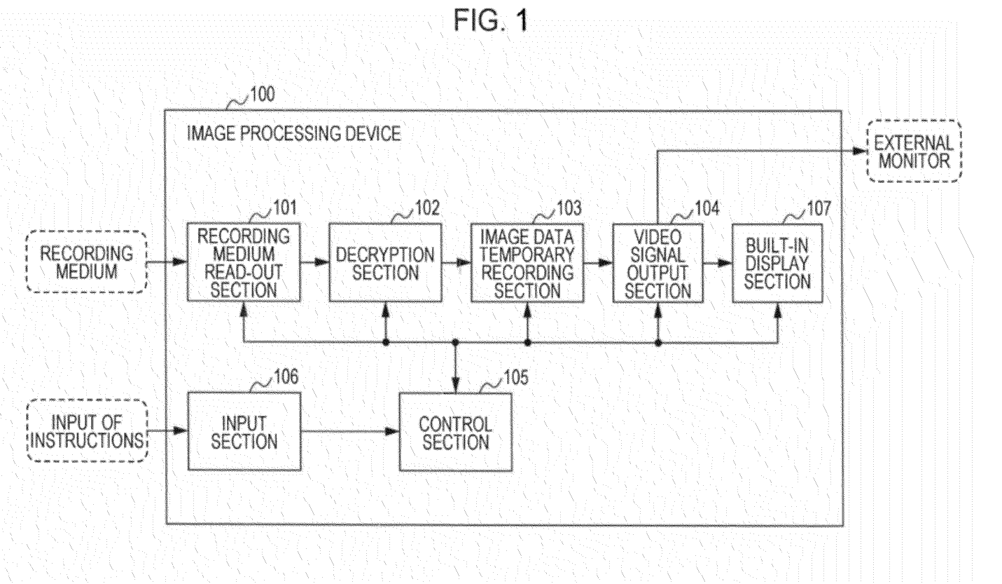

The configuration and processing of an image processing device of the disclosure will be described with reference to FIG. 1. The image processing device of the disclosure solves problems in an image correction process with regard to an image where there is a plurality of images such as a left-eye image (L image) and a right-eye image (R image) in one image frame as described above. Specifically, the image processing device of the disclosure solves problems at the time of resolution conversion such as an enlargement process or a reduction process. That is, the prevention of setting of an image value due to referencing of a pixel of another adjacent image which is not to be referenced in the vicinity of a boundary portion of LR images.

As described above, the following methods are methods where there is a left-eye image (L image) and a right-eye image (R image) in one image frame, and the image is recorded and transmitted.

(1) side by side method: a method where LR images are partitioned into left and right in one frame image and recorded and transmitted.

(2) top and bottom method: a method where LR images are partitioned into top and bottom in one frame image and recorded and transmitted.

First, in the embodiment below, a process example will be described in a case where the image is transmitted using the side by side method.

FIG. 1 is a block diagram illustrating an image processing device according to an embodiment of the disclosure.

As shown in FIG. 1, an image processing device 100 has a recording medium read-out section 101, a decryption section 102, an image data temporary recording section 103, a video signal output section 104, a control section 105, an input section 106, and a built-in display section 107.

The input section 106 receives input of an instruction from a user. The received instruction is transmitted to the control section 105. Below, a process example will be described in a case where an instruction of “display image with 3D format recorded on recording medium on external monitor” is received from a user.

The control section 105 analyses the input instruction received via the input section 106, and as a result, commands are sent out to each section.

The recording medium read-out section 101 performs data read-out from the recording medium due to the recording medium read-out command from the control section 105. As the recording medium, other than a built-in flash memory or a built-in HDD, a format such as a memory card, an optical disc such as a CD-R or a DVD-R which are able to be inserted and ejected, or a recording device on a network may be used. The data recorded on the recording medium read-out by the recording medium read-out section 101 is transmitted to the decryption section 102.

The decryption section 102 performed decryption of the data received due to a decryption command from the control section 105.

An image with 3D format is recorded in the recording medium as described above, the image with 3D format is read out from the recording medium by the recording medium read-out section 101 and provided to the decryption section 102.

Here, for example, there is a multi-picture format standard which has been standardized by CIPA as a format for storing images with multiple viewpoints such as the left-eye image (L image) and the right-eye image (R image) for three dimensional image display. The images with 3D format are recorded on the recording medium, for example, in accordance with the multi-picture format standard.

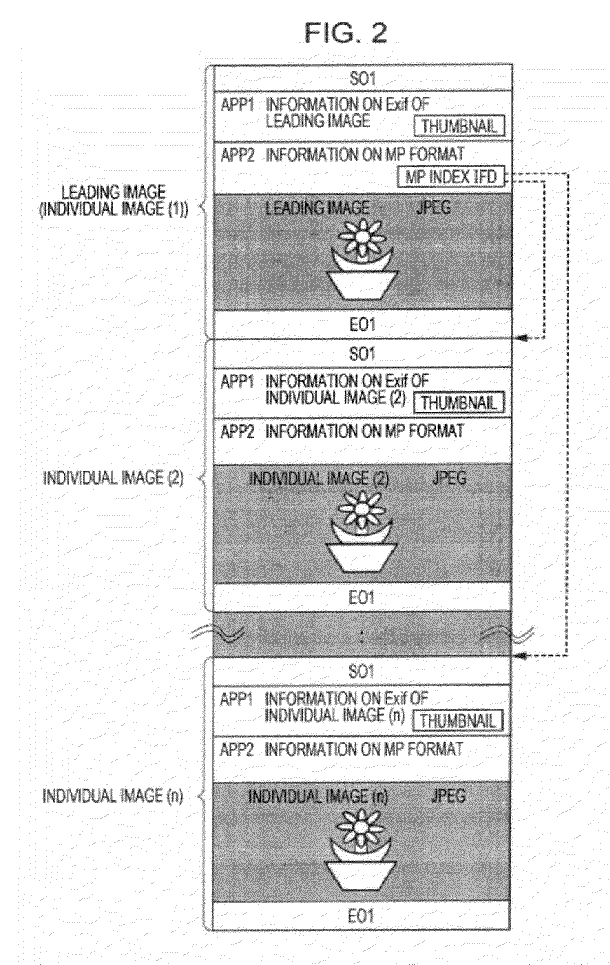

The multi-picture format standard is a format where it is possible to record individual images with the same configuration as JPEG compressed data stipulated by “Exif” which is defined as the recording format of images captured by a typical camera and to record so that a plurality of individual images are associated with each other as shown in FIG. 2. Information belonging to the multi-picture format such as association information of the left-eye image (L image) and the right-eye image (R image) is a format which is set so that recording is possible.

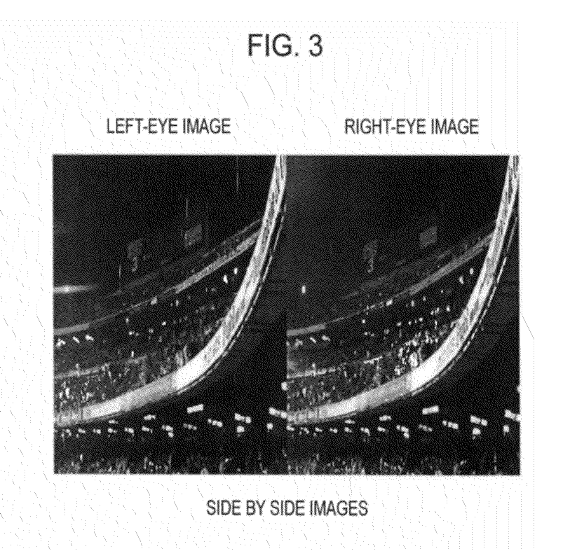

In the decryption section 102, JPEG images of [left-eye image (L image) and right-eye image (R image)] with two viewpoints, which are recorded in the recording medium and are stored in data in accordance with the multi-picture format, are read out, the JPEG images are decrypted and read out as, for example, YCbCr 422 image data, and transmitted to the image data temporary recording section 103. At the time of the transmitting, the read-out image data is transmitted in this example using the side by side format as shown in FIG. 3 and is recorded in the image data temporary recording section 103.

Here, the YCbCr 422 image data is data obtained where the sampling ratio of a luminance signal Y and color difference signals Cb and Cr is 4:2:2. There is a sampling method where one of the Cb or Cr signal values is obtained with regard to the Y signal corresponding to two pixels in the horizontal direction. According to the method, for example, the total of 24 bits of each of the 8 bits of a RGB signal with regard to one pixel is able to be expressed as 16 bits in the YCbCr 422 format and it is possible to increase the use efficiency of the memory (the image data temporary recording section 103).

The image data temporary recording section 103 is configured by a memory such as a DDR SDRAM (Double-Data-Rate Synchronous Dynamic Random Access Memory) and temporarily records the received image data. When the video signal output section 104 of a later stage is able to output, an image data output command is received from the control section 105 with regard to the image data temporary recording section 103. Then, the image data is transmitted to the video signal output section 104.

When the video signal output section 104 receives the external output command from the control section 105, output data, which is appropriate for the display section configuration of the built-in display section 107 or an external monitor, is created and output is performed based on the image data (image data with side by side format) read-out from the image data temporary recording section 103.

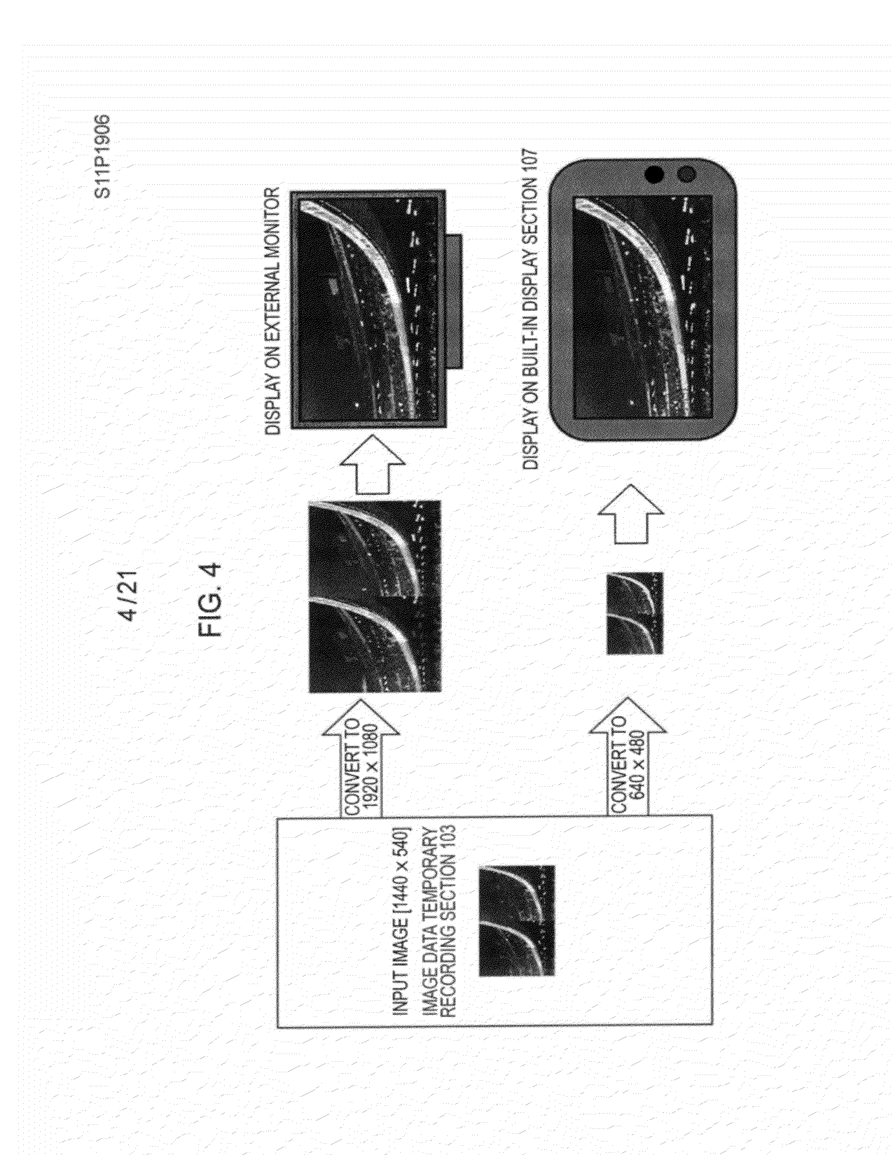

For example, in a case as shown in FIG. 4 where an external monitor is a display which is able to display image data with 1920×1080 pixels, the video signal output section 104 executes resolution conversion where the side by side images input from the image data temporary recording section 103 is set as image data with 1920×1080 pixels and the image data is output.

According to the processing, in a, for example, 3D television which is the external monitor, it is possible for the displaying and viewing of 3D images to be performed by performing control so that the L image and the R image are alternately displayed in accordance with the resolution of the television and there is the setting so that, for example, a viewer who wears shutter glasses only sees the L image with the left eye and only sees the R image with the right eye.

In addition, in a case where the built-in display section 107 is the output destination and the built-in display section 107 has a configuration which is able to output the image data with 640×480 pixels, resolution conversion is executed so that the input side by side images are set as image data with 640×480 pixels and the image data is output. Due to the processing, it is possible for the 3D images to be display on the built-in display section 107.

Here, as a 3D image display method in an external monitor or the built-in display section, it is possible to use various methods, not limited to methods where shutter glasses are necessary, such as a method where glasses which use polarizing plates are used, a method where a display is used which displays 3D images which are able to be viewed with the naked eye, or the like.

In FIG. 4, an example is shown where side by side images which are input into the video signal output section 104 from the image data temporary recording section 103 are set as image data with 1440×540 pixels. In the video signal output section 104, image correction is executed in accordance with an enlargement process or a reduction process with regard to the image data with 1440×540 pixels, image data with 1920×1080 pixels which is appropriate for the external monitor is generated, and in addition, image data with 640×480 pixels which is appropriate for the built-in display section 107 is generated.

Here, a detailed configuration and detailed processing of the video signal output section 104 will be described in further detail at a later stage.

The built-in display section 107 is configured by, for example, a liquid crystal panel.

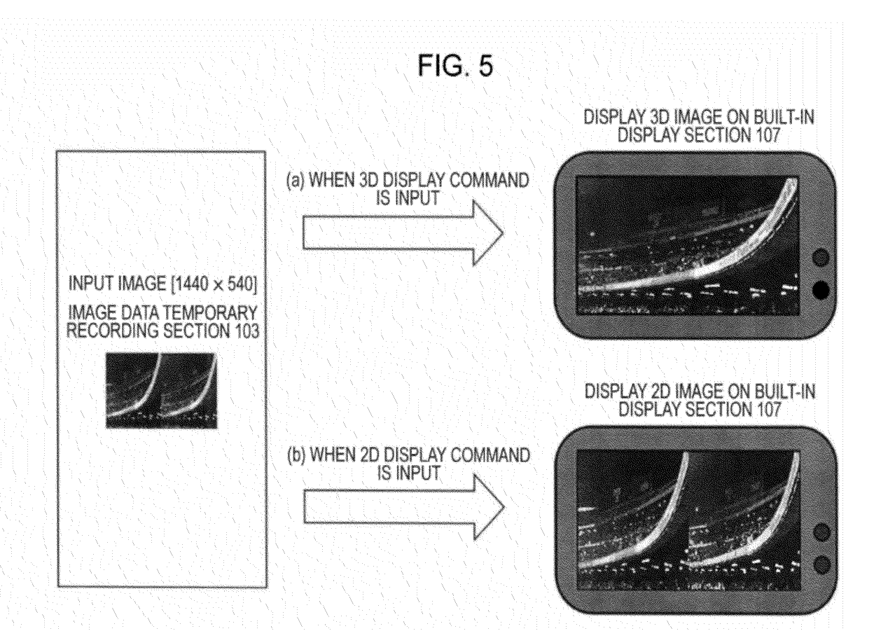

When a 3D image display command is received from the control section 105, the built-in display section 107 displays the 3D images generated by the video signal output section 104 based on the side by side image data as shown in (a) of FIG. 5. In addition, when a 2D image display command is received from the control section 105, the side by side images are displayed as shown in (b) of FIG. 5 as they are. That is, displayed as side by side images where the L image and the R image are set in one frame image.

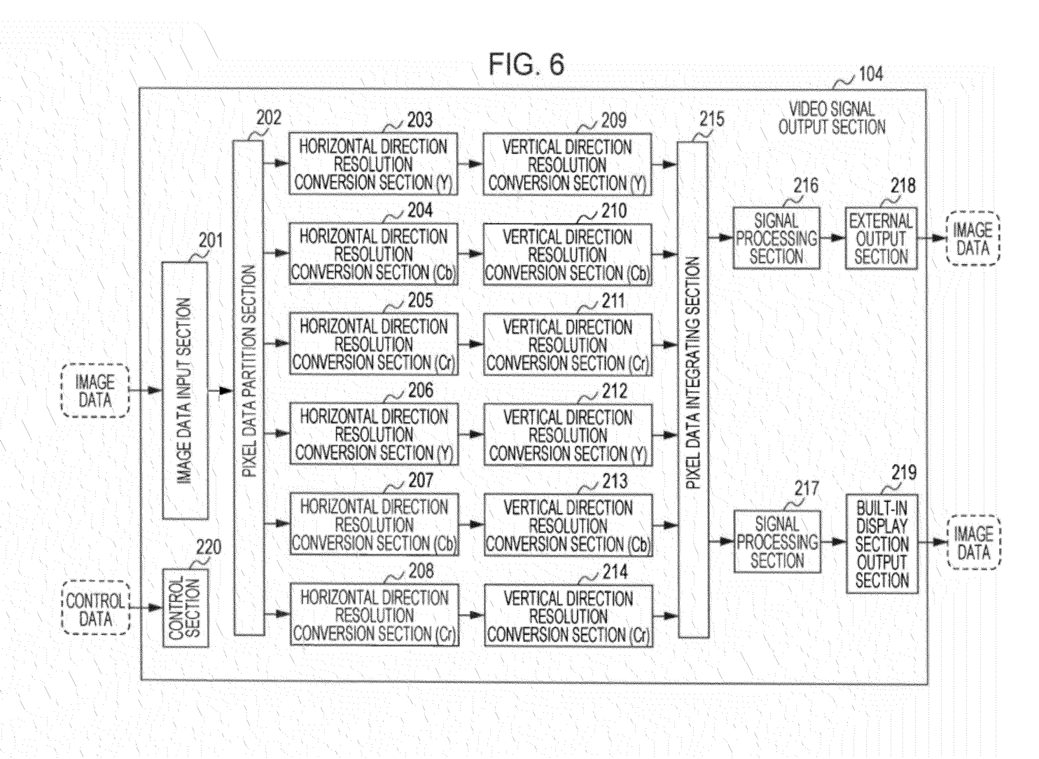

FIG. 6 is a block diagram illustrating a detailed configuration of the video signal output section 104. A detailed configuration and detailed processing of the video signal output section 104 will be described using FIG. 6.

As shown in FIG. 6, the video signal output section 104 has an image data input section 201, a pixel data partition section 202, horizontal direction resolution conversion sections 203 to 208, vertical direction resolution conversion sections 209 to 214, a pixel data integrating section 215, signal processing section 216 and 217, external output sections 218 and a built-in display section output section 219, and a control section 220.

The control section 220 receives commands from the control section 105 of the main body of the image processing device described above with reference to FIG. 1 and sends out commands with regard to the constituent sections of the video signal output section 104 shown in FIG. 6. Although not shown in order to prevent complication of the diagram, there is a command path from the control section 220 to each of the sections.

The pixel data input section 201 inputs the 3D image data recorded in the image data temporary recording section 103 by sending out an image data output command to the image data temporary recording section 103 via the control section 105 using the control section 220.

Here, as described above, the data with the side by side image format where the L image and the R image are set in one frame image is recorded in the image data temporary recording section 103 as YCbCr 422 image data.

The image data input section 201 of the video signal output section 104 shown in FIG. 6 inputs the YCbCr 422 image data from the image data temporary recording section 103. The image data is transmitted in order from the upper left pixel. The input pixels are transmitted to the pixel data partition section 202.

Since the image format is YCbCr 422 and there are two systems of output destinations of the external monitor and the built-in display section 107 in the embodiment, in the pixel data partition section 202, when a partition command is received from the control section 220, a partition process is performed where the image data received as shown in FIG. 6 is partitioned into six for each pixel component (Y, Cb, Cr) so as to perform a resolution conversion process at a later stage.

Each of the partitioned data is transmitted to the horizontal direction resolution conversion sections 203 to 208 at a later stage. The image data partition section 202 transmits a Y signal for the external monitor to the horizontal direction resolution conversion section 203, a Cb signal for the external monitor to the horizontal direction resolution conversion section 204, a Cr signal for the external monitor to the horizontal direction resolution conversion section 205, a Y signal for the built-in display section to the horizontal direction resolution conversion section 206, a Cb signal for the built-in display section to the horizontal direction resolution conversion section 207, and a Cr signal for the built-in display section to the horizontal direction resolution conversion section 208. At this time, since there are the two paths of the output destinations of the external monitor and the built-in display section 107, it is necessary to perform partition into six systems, but when the output paths increase, it is necessary to partition into a number which is three times as large as the number of paths in the case of the YCbCr 422 format.

The horizontal direction resolution conversion sections 203 to 208 receive the enlargement or reduction commands from the control section 220 as resolution conversion commands. For example, in a case where there are the settings such that the resolution of the horizontal direction of the input image is 1440, the resolution of the horizontal direction of the external monitor which outputs the images is 1920, and the resolution of the horizontal direction of the built-in display section 107 is 640, it is necessary to perform resolution conversion in accordance with the resolution of the display section of each of the output destinations with regard to the input image. The control section 220 sends out enlargement or reduction commands for the resolution conversion according to the output destination.

When the number of pixels, which are necessary for horizontal direction resolution conversion processes in the horizontal direction resolution conversion sections 203 to 208, are input, the horizontal direction resolution conversion processes are executed for each of the pixel components (Y, Cb, Cr). The details of the resolution conversion process will be described later. When the horizontal direction resolution conversion processes in the horizontal direction resolution conversion sections 203 to 208 are completed, the image data where the horizontal direction resolution conversion processes have been carried out are transmitted to the vertical direction resolution conversion sections 209 to 214.

The vertical direction resolution conversion sections 209 to 214 also receive the enlargement or reduction commands for the resolution conversion according to the output destination from the control section 220. For example, in a case where there are the settings such that the resolution of the vertical direction of the input image is 540, the resolution of the vertical direction of the external monitor which outputs the images is 1080, and the resolution of the vertical direction of the built-in display section 107 is 480, it is necessary to perform resolution conversion in accordance with the resolution of the display section of each of the output destinations with regard to the input image. The control section 220 sends out enlargement or reduction commands for the resolution conversion according to the output destination.

When the number of lines, which are necessary for vertical direction resolution conversion processes in the vertical direction resolution conversion sections 209 to 214, are input, the vertical direction resolution conversion processes are executed for each of the pixel components. The process is a process where the resolution conversion direction is different to the horizontal direction resolution conversion. When the vertical direction resolution conversion processes are completed, the image data where the resolution conversions have been carried out are transmitted to the image data integrating section 215.

The integration of the image data is performed in the image data integrating section 215. The image component data, which is generated by the resolution conversion processes being independently performed for each signal unit of YCbCr in the resolution conversion sections 203 to 214, is integrated according to an image integration command from the control section 220 and image data for output is generated. Since there is output to two systems of the external monitor and the built-in display section 107 in the embodiment, the image data which has been integrated for the external monitor is transmitted to the signal processing section 216 and the image data which has been integrated for the built-in display section 107 is transmitted to the signal processing section 217.

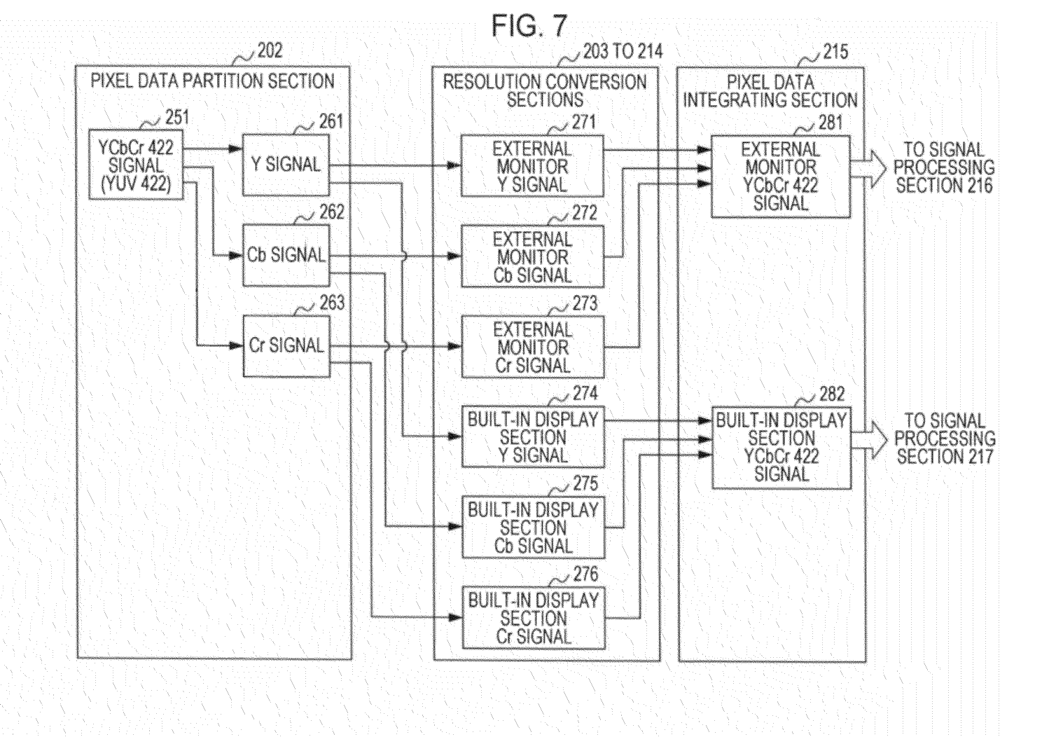

FIG. 7 shows a diagram describing a flow of a process from the pixel data partition section 202 to the pixel data integrating section 215.

The pixel data partition section 202 obtains an YCbCr 422 signal 251 from the image data input section 201 and generates a Y signal 261, a Cb signal 262, and a Cr signal 263.

The resolution conversion sections 203 to 214 independently execute the resolution conversion processers for each YCbCr signal unit. The resolution conversion is performed as a conversion process according to the resolution of the output destinations (the external monitor and the built-in display section 107 in the embodiment).

The signals of an external monitor Y signal 271, an external monitor Cb signal 272, an external monitor Cr signal 273, a built-in display section Y signal 274, a built-in display section Cb signal 275, and a built-in display section Cr signal 276 are generated due to the resolution conversion processes.

The signals are input to the pixel data integrating section 215. The pixel data integrating section 215 executes the integrating process of the three signals of the external monitor Y signal 271, the external monitor Cb signal 272, and the external monitor Cr signal 273, and an external monitor YCbCr signal 281 is generated and output to the signal processing section 216 shown in FIG. 6.

In addition, the pixel data integrating section 215 executes the integrating process of the three signals of the built-in display section Y signal 274, the built-in display section Cb signal 275, and the built-in display section Cr signal 276, and a built-in display section YCbCr signal 282 is generated and output to the signal processing section 217 shown in FIG. 6.

The signal processing sections 216 and 217 receive each type of signal process execution command from the control section 220, various image processes such as gamma correction are performed according to the output device at a later stage, and transmits to the external output section 218 and the built-in display section output section 219.

The external output section 218 and the built-in display section output section 219 perform conversion to interface signals according to the output device at a later stage. For example, image output is performed with an HDMI (High-Definition Multimedia Interface) format in a case of a signal to the external monitor and with a MIPI (Mobile Industry Processor Interface) format in a case of a signal to the built-in display section 107.

2. Details of Resolution Conversion Process

Next, the resolution conversion process executed by the horizontal direction resolution conversion sections 203 to 208 and the vertical direction resolution conversion sections 209 to 214 will be described in detail.

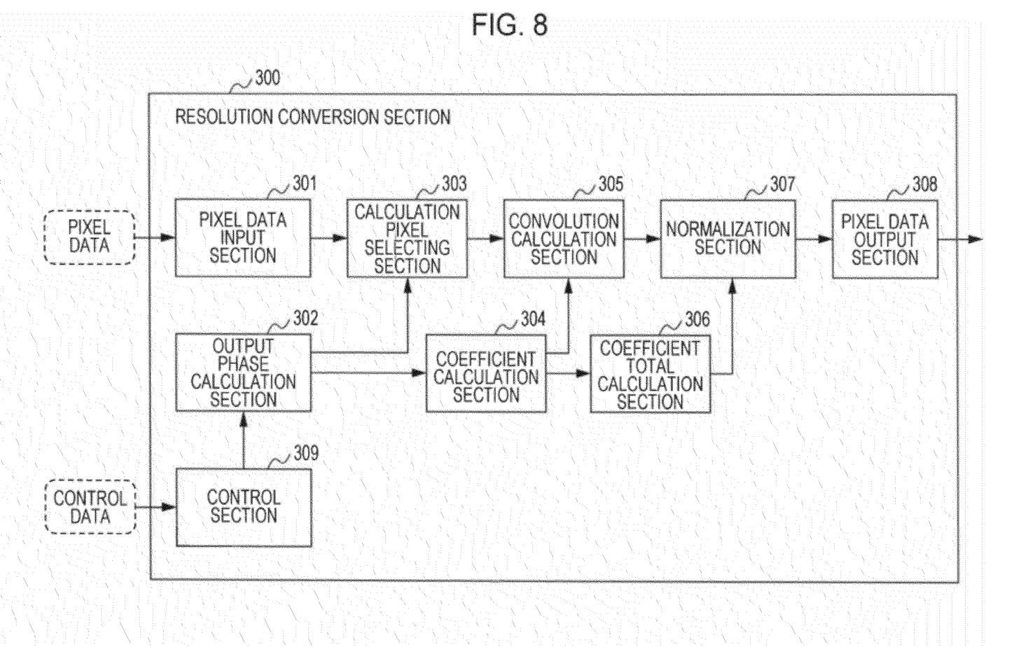

FIG. 8 shows a block diagram illustrating a resolution conversion section 300. The resolution conversion section 300 shown in FIG. 8 is the resolution conversion section shown in FIG. 6, that is, FIG. 8 is a diagram illustrating one configuration example of the respective resolution conversion sections of the horizontal direction resolution conversion sections 203 to 208 and the vertical direction resolution conversion sections 209 to 214.

Each of the horizontal direction resolution conversion sections 203 to 208 and the vertical direction resolution conversion sections 209 to 214 have the configuration of the resolution conversion section 300 shown in FIG. 8.

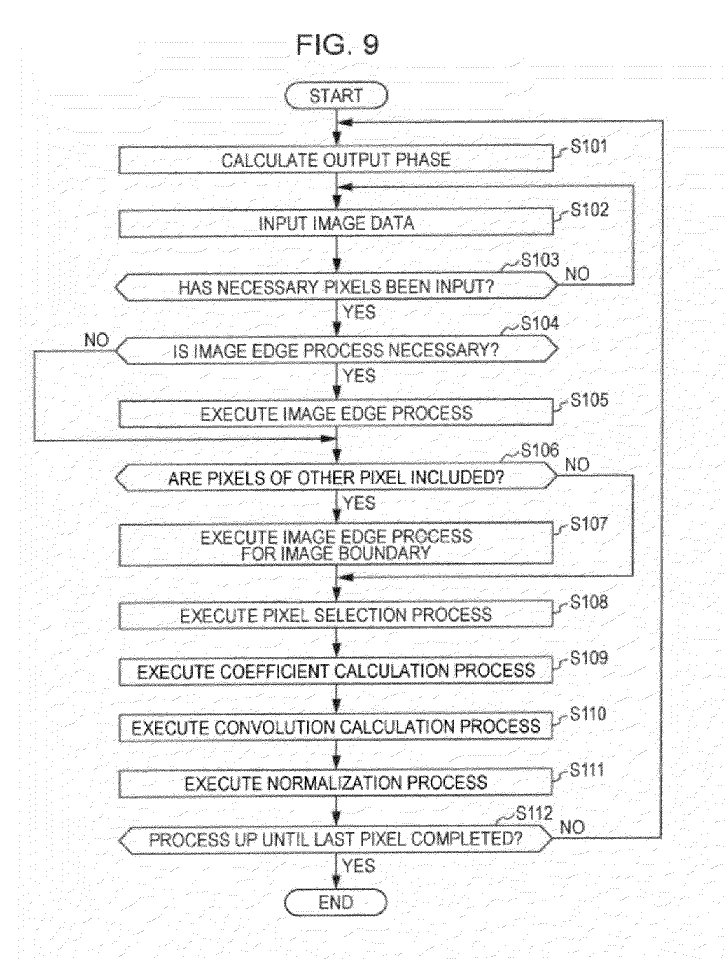

In addition, FIG. 9 shows a flow chart describing a sequence of the resolution conversion process executed in the resolution conversion section 300 shown in FIG. 8.

The details of the resolution conversion process which is executed in the resolution conversion section 300 will be described with reference to FIGS. 8 and 9.

Here, since the basic processes of the horizontal direction resolution conversion and the vertical direction resolution conversion, where the direction of the resolution conversion are different, are the same, the horizontal direction resolution conversion will be described here.

As shown in FIG. 8, the resolution conversion section 300 has a pixel data input section 301, an output phase calculation section 302, a calculation pixel selecting section 303, a coefficient calculation section 304, a convolution calculation section 305, a coefficient total calculation section 306, a normalization section 307, a pixel data output section 308, and a control section 309.

The control section 309 receives commands from the control section 105 of the main body of the device shown in FIG. 1 and sends out commands to each section of the resolution conversion section 300 shown in FIG. 8. Although not shown in order to prevent complication of the diagram, there is a command path from the control section 309 to each of the sections.

When the horizontal direction resolution of the input image and the horizontal direction resolution after enlargement or reduction processes is received from the control section 105, a process is started in accordance with the resolution conversion process flow of FIG. 9.

Here, as an example, the resolution conversion process example described below will be described as a process example where a horizontal direction resolution conversion is performed with settings where the horizontal direction resolution of the input image is 1440 and the horizontal direction resolution after resolution conversion is 1920.

That is, a resolution conversion is executed so that an output image where the number of pixels in the horizontal direction is 1920 pixels is generated with regard to an input image where the number of pixels in the horizontal direction is 1440 pixels.

Calculation of an output phase is performed in step S101 of the flow shown in FIG. 9. The output phase calculation section 302 shown in FIG. 8 receives the horizontal direction resolution information (=1440) of the input image from the control section 309 and the horizontal direction resolution information (=1920) after an enlargement or reduction process and performs a phase calculation on the output pixels based on the input information.

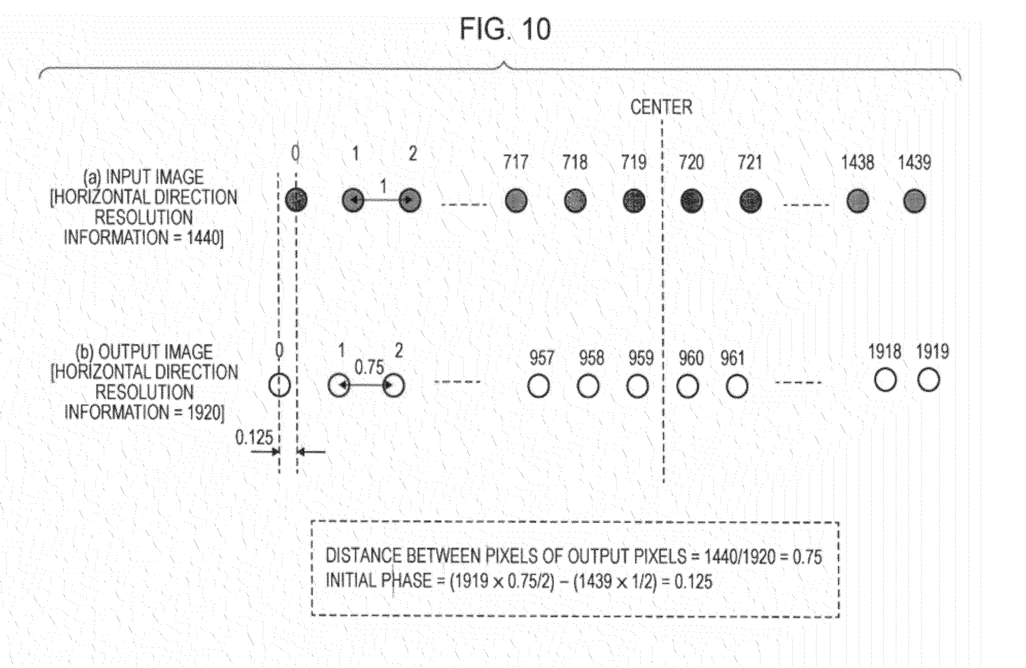

Specifically, when the horizontal direction resolution of the input image is 1440 and the horizontal direction resolution after resolution conversion is 1920, a positional relationship as shown in FIG. 10 is calculated by calculating the arrangement of the pixels.

FIG. 10 shows a pixel positioning of the input and output pixels which have different resolutions of

(a) input pixels (horizontal direction resolution=1440) and

(b) output pixels (horizontal direction resolution=1920).

The output phase calculation section 302 shown in FIG. 8 calculates that it is necessary for, for example, a phase position of the 0^{th} pixel of the output pixels to be generated in a position of −0.125 in regard to the 0^{th} pixel of the input pixels as shown in FIG. 10.

The phase of a pixel 0 of the output pixels (phase with regard to an input pixel 0) is −0.125.

Here, with the phase of the pixel 0 of the input pixels as zero, the left direction is set as −, the right direction is set as +, and the distance between adjacent pixels of the input pixels is set with a phase equal to one.

For example, a pixel with a pixel number 718 in the (a) input pixels shown in FIG. 10 has a phase equal to 718.

The output phase calculation section 302 calculates phase information corresponding to the amount of deviation from the position of the 0^{th} pixel (pixel 0) of the input pixels and outputs the calculated phase information to the calculation pixel selecting section 303.

When the phase information output is complete, the process moves to step S102.

In step S102, the pixel data is input to the pixel data input section 301 and the input pixel is output to the calculation pixel selecting section 303. When the transmitting is complete, the process moves to step S103.

In step S103, the calculation pixel selecting section 303 performs analysis of whether the pixels necessary for calculation of the pixel value of the output pixel have been input, and if it is determined that the necessary pixels have been input, selecting of pixels, (reference pixels) which are used in a calculation where the pixel value of the output pixel is calculated from the input pixels, is performed.

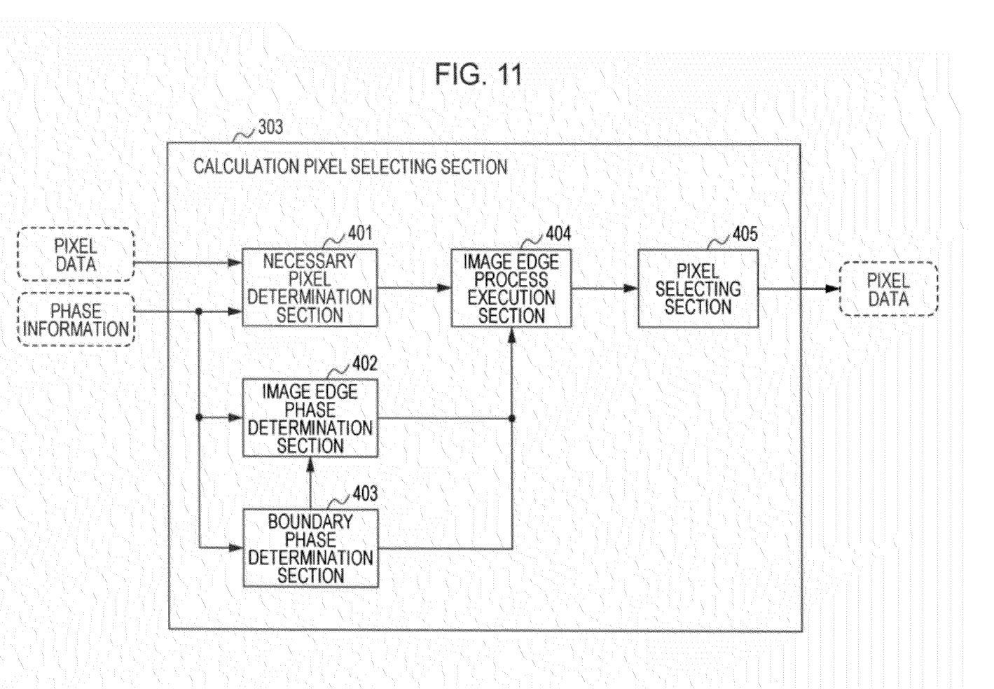

Here, an analysis process of whether the pixels necessary for calculation of the pixel value of the output pixel has been input and a reference pixel selection process is performed in a necessary pixel determination section 401 shown in FIG. 11 which illustrates a detailed configuration of the calculation pixel selecting section 303.

The necessary pixel determination section 401 confirms the input pixels necessary for calculation which generates the output pixel from the phase received from the output phase calculation section 302 and determines whether the pixels have been transmitted from the pixel data input section 301 to the calculation pixel selecting section 303.

For example, in a case where it is necessary for an output pixel with a phase of 539.5 to be generated from two pixel included in the input pixels, it is necessary to calculate the pixel value of the output pixel based on the pixel values of the input pixels. The reference pixels, which is used in the pixel value calculation of the output pixel with a phase of 539.5, is, for example, two pixels of a pixel 539 and a pixel 540 of the input pixels. In this case, the necessary pixel determination section 401 determines whether the pixel 540 has been transmitted from the pixel data input section 301 to the calculation pixel selecting section 303.

Here, when the horizontal direction resolution of the input image is 1440 and the horizontal direction resolution after resolution conversion is 1920, since the 0^{th} pixel of the output pixels shown in FIG. 10 has a phase of −0.125, if the 0^{th} pixel of the input pixels is transmitted to the calculation pixel selection section 303, it is determined that the necessary pixel has been input.

In a case where the necessary pixel determination section 401 determines that the necessary pixels have been input to the calculation pixel selecting section 303, the process moves to step S104. In addition, if it is not determined that the necessary pixels have been input, the process moves to step S102 again and the next pixel is input.

In step S104, the calculation pixel selecting section 303 performs determination of whether or not an image edge process is necessary in an image edge phase determination section 402 shown in FIG. 11. Here, the image edge process in the embodiment has a meaning of a setting and determination process of the reference pixels which is executed in a case of determining the pixel value of the output pixel such as an edge portion of the image.

As described above, in the case where the pixel value of the output pixel with a phase of 539.5 is calculated, it is possible to use the two pixels of the pixel 539 and the pixel 540 of the input pixels as the reference pixels used in the pixel value calculation. However, in the settings of FIG. 10, the phase of the output pixel 0 which is the pixel on the left edge in the output pixels is −0.125 and there are no input pixels more to the left of the position which corresponds to this phase. Accordingly, in regard to the output pixel 0, the pixel value calculation process, which uses an algorithm where the two input pixels in positions which interpose the output pixel are reference pixels, is not possible in the same manner as the pixel value calculation process of the output pixel with a phase of 539.5 described above.

In the same manner, in regard to an output pixel 1919 on the right edge of the output pixels shown in FIG. 10, there are no input pixels on the right of the output pixel 1919 and the pixel value calculation process, which uses an algorithm where the two input pixels in positions which interpose the output pixel are the reference pixels, is not possible.

Accordingly, in regard to the pixels in edge portions, a pixel value estimation algorithm unique to the image edge portions (image edge) is used which is different to the algorithm which uses the two input pixels on the left and right of the output pixel position as the reference pixels. The setting and determination processes of the reference pixel, which are used in the pixel value setting process using the pixel value estimation algorithm unique to the image edge, are referred to as an image edge process.

In a case where there are no input pixels which are able to be referenced in the left and right positions of the phase of the output pixel, it is determined that the image edge process is necessary and the process moves to step S105. If it is determined that the image edge process is not necessary, the process moves to step S106.

In a case where there are no input pixels which are able to be referenced in the left and right positions of the phase of the output pixel and it is determined that the image edge process is necessary, an image edge process execution section 404 of the calculation pixel selecting section 303 shown in FIG. 11 executes the image edge process in step S105.

The image edge process is a process where there is the setting and determining of the reference pixels which are used in the pixel value calculation of the output pixel in the case where there are no input pixels, which are necessary for calculating the pixel value of the output pixel, on both sides of the pixel position of the output pixel as described above.

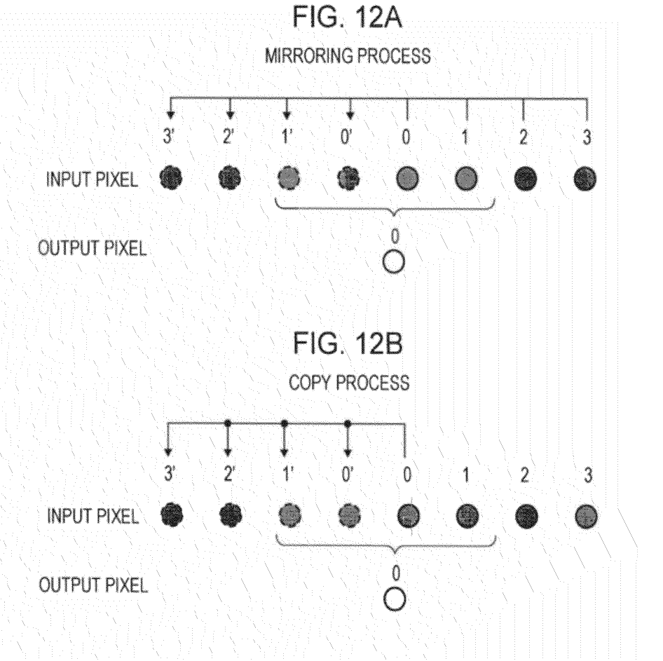

Examples of the image edge process will be described with reference to FIGS. 12A and 12B.

FIGS. 12A and 12B show the two following image edge process examples.

(a) Mirroring Process

(b) Copy Process

The mirroring process shown in FIG. 12A is a process where virtual pixels (pixels 0′, 1′, 2′, and 3′) are formed with a formation as though pixels (pixels 0, 1, 2, and 3) of the image edge portion are reflected in a mirror along the boundary as shown in the diagram.

The copy process shown in FIG. 12B is a process where virtual pixels (pixels 0′, 1′, 2′, and 3′) are formed by copying the pixel (pixel 0) of the image edge portion.

The pixel value of the output pixel is calculated using the virtual input pixels as the reference pixels.

Here, since the example described here is an example where the pixel value of the output pixel is set using the two pixels of the input pixels as the reference pixels, the values calculated as the pixel value of the output pixel is the same in the case where the mirroring process shown in FIG. 12A is used and in the case where the copy process shown in FIG. 12B is used.

The reference pixels are not limited to the two pixels and techniques are possible where more pixels such as four pixels are used as the reference pixels. In such a case, the calculated pixel values of the output pixel are different in the case where the mirroring process shown in FIG. 12A is used and in the case where the copy process shown in FIG. 12B is used.

Here, the mirroring process and the copy process are described in this example as image edge process examples, but it is possible to execute pixel value estimation according to another image edge process.

If the image edge process is completed in step S105 of the flow chart shown in FIG. 9, the process moves to step S106.

In step S106, a boundary phase determination section 403 of the calculation pixel selecting section 303 shown in FIG. 11 performs determination of whether or not pixels of two different images of the left-eye image and the right-eye image are included as the input pixels which are referenced in the pixel value calculation of the output pixel.

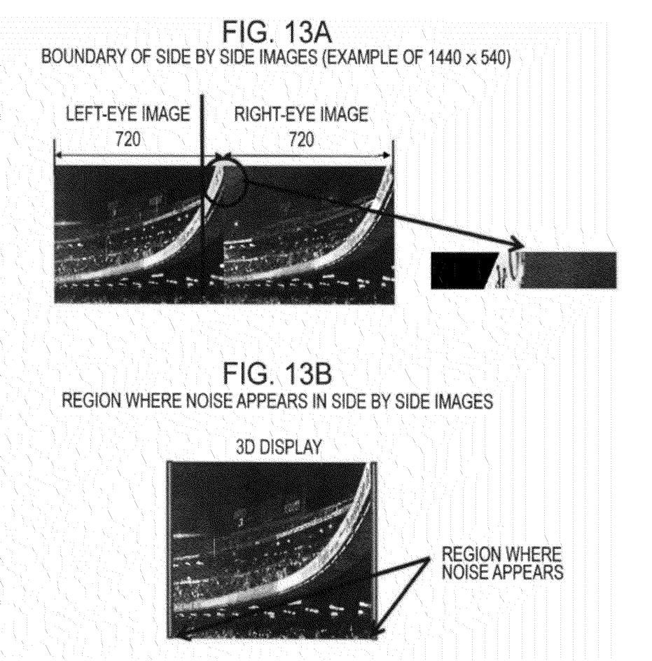

As described above, in the image transmitting format using side by side format where a three dimensional (3D) image is configured by the left-eye image (L image) and the right-eye image (R image), the left-eye image (L image) and the right-eye image (R image) are contained within a left region and a right region of one image frame as shown in FIG. 13A. The side by side image is a format where the left-eye-image (L image) and the right-eye image (R image) are connected in the left and right as shown in FIG. 13A.

In regard to such an image, in a case of performing the resolution conversion process which generates the output pixel using a plurality of pixels, there is influence of the pixel value of a completely different image region when performing a process of calculating the pixel value of the output pixel using the pixels of two different images of the left-eye image (L image) and the right-eye image (R image) as the reference pixels in a case of generating the output pixel in the boundary portion of the two images (the L image and the R image).

When executing the three dimensional image display using the L image or the R image generated by performing setting of the pixel value of the output pixel with a pixel which configures another image as the reference pixel in this manner, the pixel values of the pixels in both edges of the image as shown in FIG. 13B are pixels which include considerable noise which is significantly different from the pixel values of the pixels inside the image. This is noise generated by the setting of the pixel value of the output pixel being performed using a pixel of the R image as the reference pixel when generating the L image in the boundary portion of the LR images. In the same manner, similar noise is generated by using a pixel of the L image as the reference pixel when generating the R image.

Since determination of whether or not pixels of two different images of the left-eye image and the right-eye image are included as the input pixels which are referenced in the pixel value calculation of the output pixel, the boundary phase determination section 403 of the calculation pixel selecting section 303 shown in FIG. 11 performs a determination process using (equation 1) shown below.

Range of Noise-Generating Output Pixel: (output image resolution−number of necessary pixels for output pixel generation)/2−(output image resolution+number of necessary pixels for output pixel generation−2)/2 (equation 1).

Here, the number of necessary pixels for generation of the output pixel is the number of pixels of the input pixels which are referenced when generating the output pixel.

The output pixel calculated using the above equation shows a position in the horizontal direction of the output pixels where the smallest value is the left edge pixel equal to zero and the largest value is the right edge pixel equal to a value according to the resolution (for example, 1919).

In regard to the output pixel shown by the output pixel position calculated using (equation 1) described above, it is determined that pixels of the two different images of the left-eye image and the right-eye image are included as the referenced input pixels.

In a case where the output pixel is generated using the two pixels where the horizontal direction resolution of the input image shown in FIG. 10 is 1440 and the horizontal direction resolution after resolution conversion is 1920, (equation 1) described is satisfied when the phase of the output pixel is a pixel 959 and a pixel 960.

That is,

(1920−2)/2˜(1920+2−2)/2=(1918)/2˜(1920)/2=959˜960

and this leads to the possibility that pixels of two different images of the left-eye image and the right-eye image are set as the reference pixels in the pixel value calculation process of the output pixel 959 and the output pixel 960.

In step S106 of the flow chart shown in FIG. 9, when the boundary phase determination section 403 shown in FIG. 11 performs an image boundary phase determination process using (equation 1) described above and determines that there is an output pixel position where there is a possibility that pixels of two different images of the left-eye image and the right-eye image are set as the reference pixels in the pixel value calculation process of the output pixel, the determination in step S106 is Yes and the process proceeds to step S107.

On the other hand, when it is determined that there are no output pixel positions where there is a possibility that pixels of two different images of the left-eye image and the right-eye image are set as the reference pixels in the pixel value calculation process of the output pixel, the determination in step S106 is No and the process proceeds to step S108.

In step S107, the image edge process execution section 404 of the calculation pixel selecting section 303 shown in FIG. 11 performs the image edge process at the image boundary.

That is, in a case where the position of the output pixel where the pixel value calculation is performed is in the range of (equation 1) described above, it is determined that the output pixel is a boundary portion pixel where there is influence of another image as described above and the image edge process is executed in the same manner as the pixel in the image edge portion also with regard to the boundary portion in order to prevent noise generation.

The image edge process is, for example, a process described before with reference to FIGS. 12A and 12B and is the processes of

(a) Mirroring Process

(b) Copy Process.

Due to this process, the setting process of the reference pixel used in the calculation process which determines the pixel value of the output pixel, that is, the image edge process is executed.

Even in the boundary portion of the LR images, by executing the image edge process in the same manner as the image edge portion, setting of the pixel value of the output pixel is possible where the influence of the pixel value of another image is removed when determining the output pixel in the boundary portion of the LR images.

That is, a process is executed where only the input pixels in a L image region are used as the reference pixels in a case where the pixel value of the output pixel in the L image is calculated and only the input pixels in a R image region are used as the reference pixels in a case where the pixel value of the output pixel in the R image is calculated.

As a result, the pixel value calculation of the output pixel is executed without using pixels of a different image as the reference pixels and image generation is possible where image quality is improved with no noise generated as described before with reference to FIG. 13B.

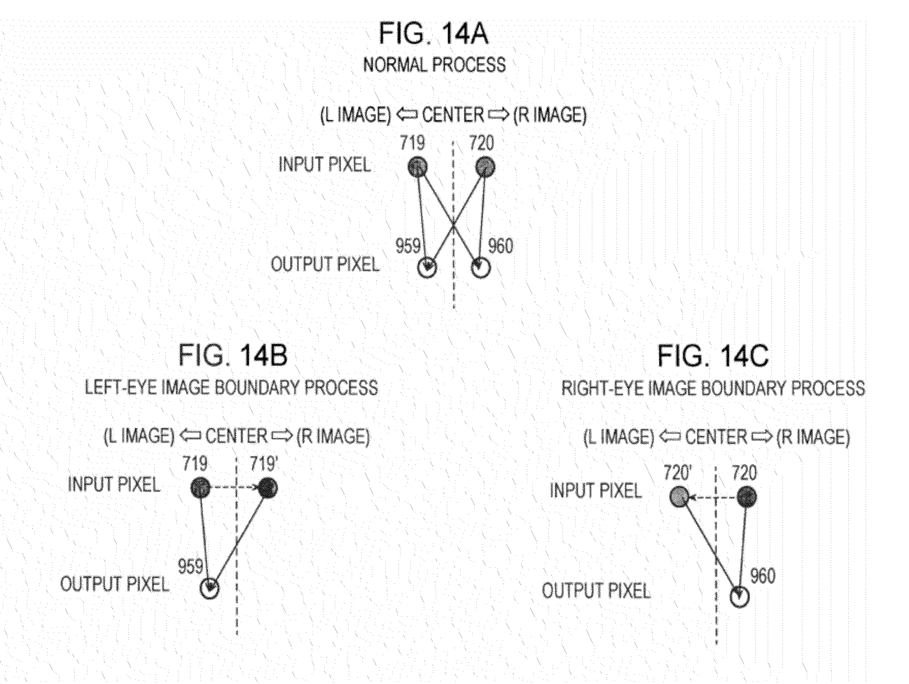

A specific example of the output pixel generation process in the boundary portion of the LR images will be described with reference to FIGS. 14A to 14C.

For example, an example of a case will be described where the output pixel 959 is generated when the horizontal direction resolution of the input image shown in FIG. 10 is 1440 and the horizontal direction resolution after resolution conversion is 1920.

In a case where the output pixel 959 of the left-eye image (L image) is generated, for example, in a normal selection process of the reference pixel as shown in FIG. 14A, that is, when a pixel 719 and a pixel 720 which are the input pixels on the left and right of the output pixel position are set as the reference pixels, the pixel 719 is in the L image in the input image but the pixel 720 is in the R image in the input image. Accordingly, pixels of two different images are used as the reference pixels.

In the boundary portion of the LR images, the normal process is not performed and a process such as that shown in FIG. 14B is performed.

As shown in FIG. 14B, a virtual pixel 719′ is generated using the mirroring process or the copy process described before with reference to FIGS. 12A and 12B on the pixel 719 which is the boundary pixel in the left-eye image of the input image and the pixel value calculation of the output pixel 959 is performed with the pixel 719 and the pixel 719′ as the reference pixels.

In the same manner, in a case where the output pixel 960 in the R image is generated in a boundary portion of the LR images, as shown in FIG. 14C, a virtual pixel 720′ is generated using the mirroring process or the copy process described before with reference to FIGS. 12A and 12B on the pixel 720 which is the boundary pixel in the right-eye image of the input image and the pixel value calculation of the output pixel 960 is performed with the pixel 720 and the pixel 720′ as the reference pixels.

In step S107 in the flow chart shown in FIG. 9, the image edge process execution section 404 of the calculation pixel selecting section 303 shown in FIG. 11 executes the image edge process in this manner when generating the output pixel in the boundary portion.

When the image edge process in step S107 is executed, the process moves to step S108.

In step S108, an actual selection process of the pixel used by a pixel selecting section 405 in the calculation of the setting of the pixel value of the output pixel. That is, the selection of the reference pixel is performed. For example, in a case where the output pixel is calculated using two input pixels, pixel selection is executed as below.

(a) in a case where the 0^{th} pixel of the output pixels in the example in FIG. 10 is generated,

the virtual pixel 0′, which is based on the input pixel 0 and generated in the image edge process such as the mirroring process or the copy process executed in step S105, and the input pixel 0 are selected as the reference pixels.

(b) in a case where the 2^{nd} pixel of the output pixels is generated,

the pixel 1 of the input pixels and the pixel 2 of the input pixels are selected as the reference pixels.

(c) in a case where the 959^{th} pixel of the output pixels is generated,

the virtual pixel 719′, which is based on the input pixel 719 and generated in the image edge process such as the mirroring process or the copy process executed in the image edge process in step S107, and the input pixel 719 are selected as the reference pixels.

The pixel selection process is executed in this manner.

The pixel selecting section 405 executes the reference pixel selection process according to the position of the output pixel in this manner. The selected pixels are transmitted to the convolution calculation section 305 shown in FIG. 8. When transmitting is completed, the process moves to step S109 in the flow chart shown in FIG. 9.

In step S109, the coefficient calculation section 304 performs a coefficient calculation which is equivalent to weightings of a plurality of reference pixels selected in order to calculate the pixel value of the output pixel based on the output phase information received from the output phase calculation section 302. There are various methods in interpolation methods which use the input pixels in the vicinity of the pixel positions of the output pixels, but an example of linear interpolation which uses two pixels in the vicinity is described in the embodiment. There is a process where the pixel value of the output pixel is calculated using linear interpolation with the two pixels as the reference pixels. Here, it is also possible to use other techniques.

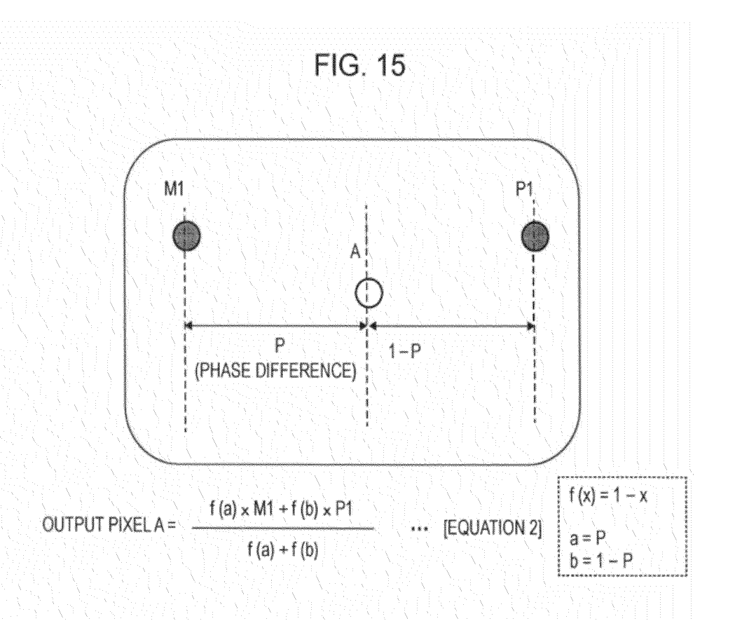

An example of a pixel value calculation process of the output pixel using linear interpolation will be described with reference to FIG. 15.

In a case where an output pixel A is generated as shown in FIG. 15, two vicinity pixels which are near the output pixel A are used. The two vicinity pixels are configured by the input pixels or virtual pixels generated based on the input pixels. In a case where the image edge process with regard to the image edge portion or the image boundary portion is performed, virtual pixels are included.

The phase difference with an input pixel M1 which is closest in the minus direction (the left direction in FIG. 15) from the phase which generates the output pixel A shown in FIG. 15 is set as

phase difference=P.

With the interval between pixels in the input pixels set as one, the phase difference with an input pixel P1 which is closest in the plus direction (the right direction in FIG. 15) from the phase which generates the output pixel A is set as

phase difference=1−P.

The pixel value of the output pixel A is calculated using (equation 2) shown below.

Pixel value of output pixel A=(f(a)×M1+f(b)×P1)/(f(a)+f(b)) (equation 2)

Here, f(x)=1−x,

a=P, and

b=1−P.

(Equation 2) described above is an equation where the coefficients f(a) and f(b), which are equivalent to weightings according to the distance between the output pixel and the reference pixels, are set and the pixel value of the output pixel A is calculated using a linear interpolation process based on the pixel values M1 and P1 of the two reference pixels.

Here, f(x)=1−x for the linear interpolation. The coefficients are f(a) and f(b) in equation 2 and are values according to the distance (phase difference) between the output pixel and the reference pixels.

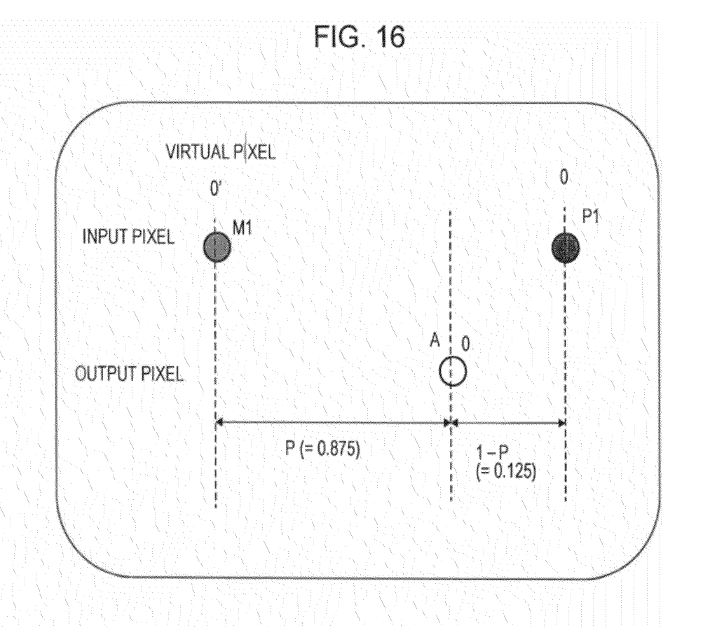

An example of the coefficient calculation will be described with reference to FIG. 16. The example shown in FIG. 16 shows an example of a pixel value calculation process of the 0^{th} pixel of the output pixels shown in FIG. 10.

The phase of the output pixel 0 which is the target of the pixel value calculation is −0.125.

The reference pixels which are used in the pixel value calculation of the output pixel 0 are the input pixel 0 shown in FIG. 16 and the virtual pixel 0′ generated using the image edge process such as the mirroring process or the copy process based on the input pixel 0.

When determining the coefficients in this case,

f(a)=1−(P)=1−0.875=0.125, and

f(b)=1−(1−P)=1−0.125=0.875.

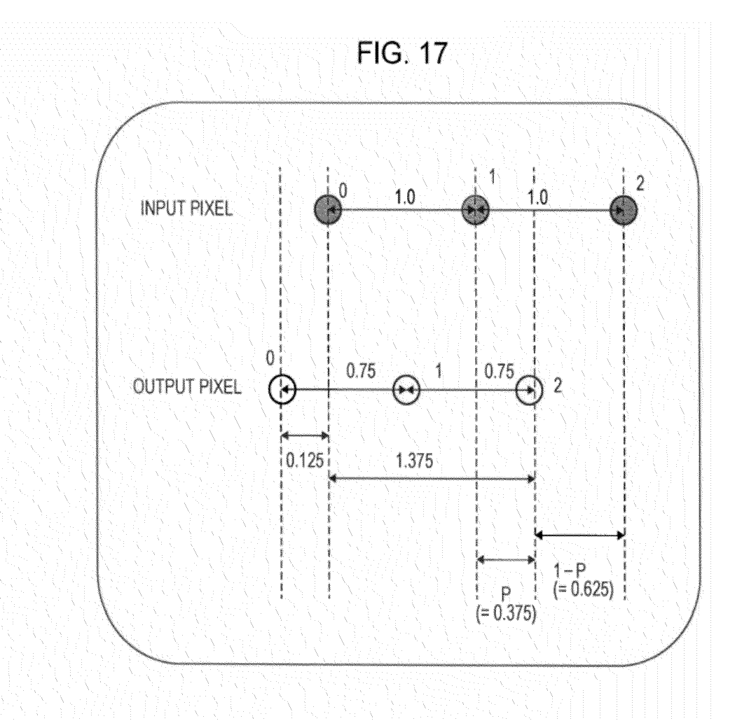

Furthermore, an example of the pixel value calculation process of the pixel 2 of the output pixels shown in FIG. 10 is described with reference to FIG. 17.

The phase of the output pixel 2 which is the target of the pixel value calculation is

0.75×2−0.125=1.375.

The reference pixels which are used in the pixel value calculation of the output pixel 2 are the input pixel 1 and the input pixel 2 shown in FIG. 17.

When determining the coefficients in this case,

f(a)=1−(P)=1−(0.375)=0.625, and

f(b)=1−(1−P)=1−0.625=0.375.

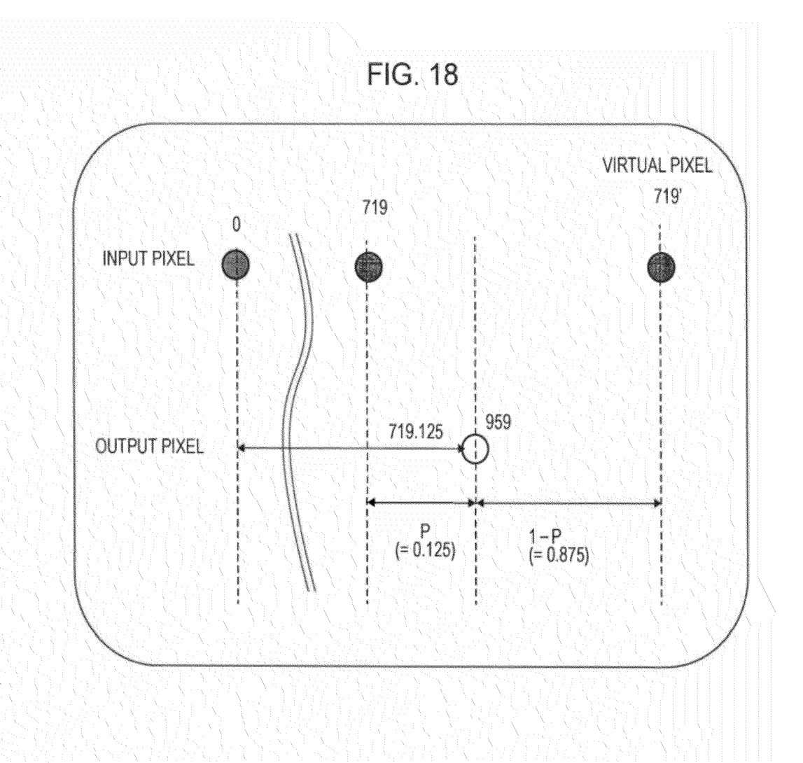

Furthermore, an example of the pixel value calculation process of the pixel 959 of the output pixels shown in FIG. 10 is described with reference to FIG. 18.

The phase of the output pixel 959 which is the target of the pixel value calculation is

0.75×959−0.125=719.125.

The reference pixels which are used in the pixel value calculation of the output pixel 959 are the input pixel 719 shown in FIG. 18 and the virtual pixel 719′ generated using the image edge process such as the mirroring process or the copy process based on the input pixel 719.

When determining the coefficients in this case,

f(a)=1−(P)=1−0.125=0.875, and

f(b)=1−(1−P)=1−0.875=0.125.

In this manner, the coefficient total calculation section 306 calculates the coefficients according to the distance (phase difference) between the output pixel and the reference pixels in step S109 of the flow chart shown in FIG. 9.

When the coefficient calculation in step S109 is completed, the determined coefficient values are output to the convolution calculation section 305 and the coefficient total calculation section 306.

In the coefficient total calculation section 306, the total of the coefficients received from the coefficient calculation section 304 is calculated and the value of the denominator of (equation 2) described above is calculated. That is,

pixel value of output pixel A=(f(a)×M1+f(b)×P1)/(f(a)+f(b)) (equation 2).

The total of the coefficients shown in the denominator of (equation 2) described above, that is,

the total of the coefficients=(f(a)+f(b))

is calculated.

Here, in this example, the total of the coefficients (f(a)+f(b)) is normally one due to the linear interpolation. When the calculation of the total of the coefficients is completed, the process moves to step S110 of the flow chart shown in FIG. 9.

In step S110, the convolution calculation section 305 performs a convolution calculation. The value of the numerator of (equation 2) described above is calculated in the convolution calculation section 305 using the pixel values of the reference pixels selected by the pixel selecting section 405 in the calculation pixel selecting section 303 and the coefficient values (f(a) and f(b)) determined by the coefficient calculation section 304.

That is,

pixel value of output pixel A=(f(a)×M1+f(b)×P1)/(f(a)+f(b)) (equation 2).

The value shown in the numerator in (equation 2) described above, that is,

(f(a)×M1+f(b)×P1)

is calculated.

For example, in the example of the pixel value calculation process of the output pixel 2 described with reference to FIG. 17,

coefficient f(a) of input pixel 1 which is reference pixel=0.625, and

coefficient f(b) of input pixel 2 which is reference pixel=0.375.

At this time, in a case where the pixel value of the input pixel 1 is 75 and the pixel value of the pixel value 2 is 200, the value shown in the numerator of (equation 2) described above, that is,

(f(a)×M1+f(b)×P1)

is calculated as below.

f(a)×M1+f(b)×P1=0.625×75+0.375×200=121.875.

When the calculation process of step S110 in the flow chart shown in FIG. 9 is completed, the calculation result is transmitted to the normalization section 307 and the process moves to step S111.

In step S111, the normalization section 307 performs a normalization process using the result of the convolution calculation from the convolution calculation section 305 and the result of the coefficient total calculation from the coefficient total calculation section 306. The normalization process in the embodiment is a process where the pixel value of the output pixel is calculated in accordance with equation 2 described above. In this example of linear interpolation, since the total of the coefficients is normally one, the result of the convolution calculation is the calculation result in step S111. When the normalization process is completed, the calculation result is transmitted to the pixel data output section 308 and the process moves to step S112.

In step S112 of the flow chart shown in FIG. 9, output is performed for every certain number of pixels using the pixel data output section 308. When it is determined that the process has been completed up until the last pixel, the process ends. In addition, a case where it is not determined that the process has been completed up until the last pixel, the process moves to step S101 and the generation process continues again for the next output pixel.

In this manner, in the process of the disclosure, the image edge process is executed for the image edge portion in the pixel value calculation process of the output pixels in the boundary portion of the LR images. Due to the image edge process in the image boundary portion, the setting of the pixel value of the output pixel for the L image is executed with only the pixels of the L image in the input pixels as the reference pixels. In the same manner, the setting of the pixel value of the output pixel for the R image is executed with only the pixels of the R image in the input pixels as the reference pixels.

Due to this process, processes are prevented where a pixel value of a different image is referenced and high-quality image generation is possible where there is no noise generated in the boundary portion of the LR images. Specifically, in a case where side by side images are output to a 3D monitor, excellent image output where there is no influence from pixels in an opposite eye image is possible.

3. Process Example when Image has Top and Bottom Format

The embodiment described above describes a process example in a case where resolution conversion is executed in the image processing device with regard to image data with side by side format.

The image with side by side format uses a method where the left-eye image (L image) and the right-eye image (R image) are set in the left and right regions of one image frame.

Other than this, as a method of 3D image data transmission, there is the top and-bottom format where the left-eye image (L image) and the right-eye image (R image) are set in the top and bottom regions of one image frame.

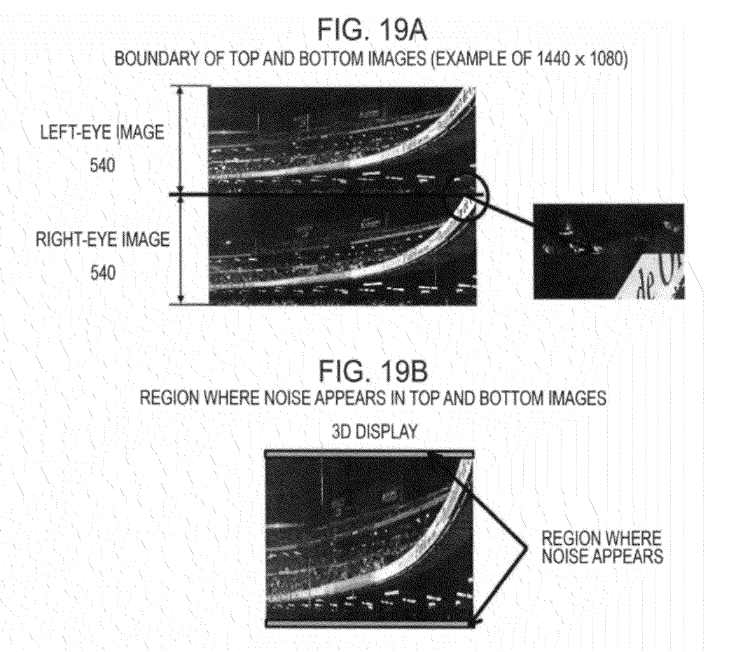

For example, the format of the data shown in FIG. 19A is the top and bottom format.

In a case where the process according to the disclosure is not executed, the position of noise when displaying in 3D is both side as shown in FIG. 13B in the case of side by side, but in the case of top and bottom, the position of noise is top and bottom as shown in FIG. 19B. This is because the boundary of the images is in the vertical direction.

In this manner, there is the boundary portion of the L image and the R image even in the top and bottom format and image generation is possible where noise is reduced by using the process of the disclosure.

The process with regard to the image with top and bottom format is basically the same as the process with regard to the image with side by side format described above, and the process is performed by executing the image edge process in the boundary portion of the LR images and selecting the reference pixels only from the same image as the output image.

In the process with regard to the image with side by side format, in the horizontal direction resolution conversion sections 203 to 208 shown in FIG. 6, a process is performed in the same manner as the image edge process at the image boundary using the boundary phase determination section 403 shown in FIG. 11.

On the other hand, in the process with regard to the image with top and bottom format, in the vertical direction resolution conversion sections 209 to 214 shown in FIG. 6, a process is performed in the same manner as the image edge process at the image boundary using the boundary phase determination section 403 shown in FIG. 14.

Due to the process, resolution conversion is possible where the influence of pixels of the opposite eye image (the right-eye image with regard to the left-eye image and the left-eye image with regard to the right-eye image) is prevented when the top and bottom image is output to a 3D monitor.

4. Resolution Conversion Process of Images with Multiple Viewpoints

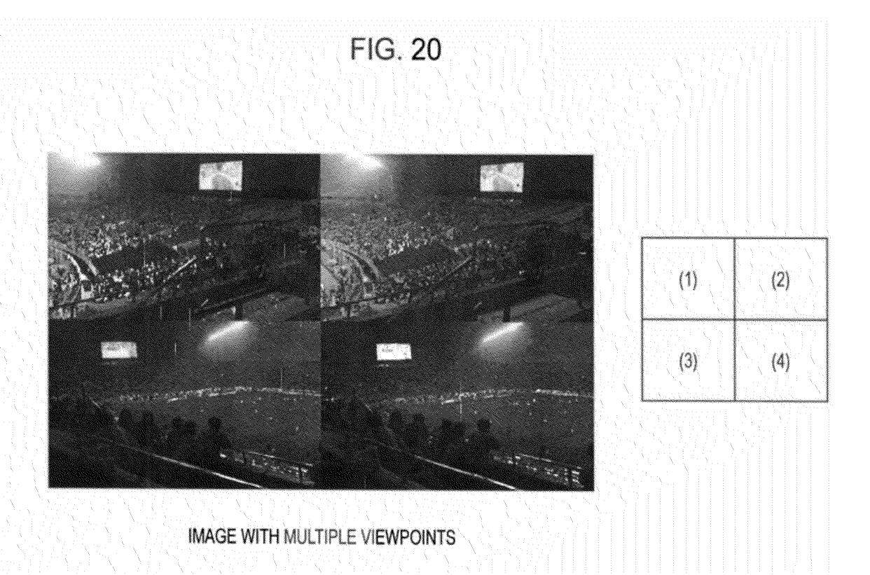

The image processing device of the disclosure is effective in the case of not only a process with regard to an image where there are the left-eye image (L image) and the right-eye image (R image) which configure a three dimensional image but also, for example, in the case of a process with regard to an image which includes images with multiple viewpoints are included in one image frame as shown in FIG. 20.

The image shown in FIG. 20 is configured by each of the images of

(1) left-eye image in the right direction,

(2) right-eye image in the right direction,

(3) left-eye image in the left direction, and

(4) right-eye image in the left direction.

It is possible for an image such as this to be displayed in 3D on a specialized monitor by, for example, a user selecting an image in a preferred direction on the left side or the right side.

If there is a setting where a plurality of different images is recorded in one image frame in this manner, there are boundaries for each image. In regard to the boundary portions, by performing the image edge process described above, that is, the image edge process where only pixels of the input image which is the same as the output image are set as the reference pixels, it is possible to generate high-quality images.

That is, when calculating the pixel value of the output pixel in execution of the resolution conversion and the like at the image boundary portion, it is possible to set the pixel value of the output pixel by referencing only the pixel values of the input image which is the same as the output image without referencing pixels of images different from the output image.

In a case of an image with four partitions such as that shown in FIG. 20, in both the horizontal direction resolution conversion sections 203 to 208 and the vertical direction resolution conversion sections 209 to 214 shown in FIG. 6, it is necessary that a process is performed in the same manner as the image edge process at the image boundary using the boundary phase determination section 403 shown in FIG. 11.

Even in a case where the number of partitions increases, it is necessary that the image boundary is determined in the same manner and a process is performed in the same manner as the image edge process at the image boundary.

5. Switching Process Between Three Dimensional Images (3D) and Two Dimensional Images (2D)

For example, with regard to the built-in display section 107 of the image processing device 100 shown in FIG. 1, it is possible for 2D images to be displayed due to a process where a two dimensional (2D) image display command is output from the control section 105 or a process where an external monitor is set to 2D display.

In a case where the data received when the data which is read out from the recording medium read-out section 101 is decoded in the decryption section 102 is simply a JPEG image and not a format which expresses multiple viewpoints such as a multi-picture format or the like, that a JPEG image has been received is notified from the decryption section 102 to the control section 105 and the control section 105 performs a process for 2D display in each section. Specifically, other than transmitting a 2D display command to the built-in display section 107, a process is executed where it is normally determined in resolution conversion in step 5106 in the flow shown in FIG. 9 that “pixels of another image are not included” and the process moves to step S108.

In this case, the image edge process is not executed in the image boundary portion.

6. Hardware Configuration Example of Image Processing Device

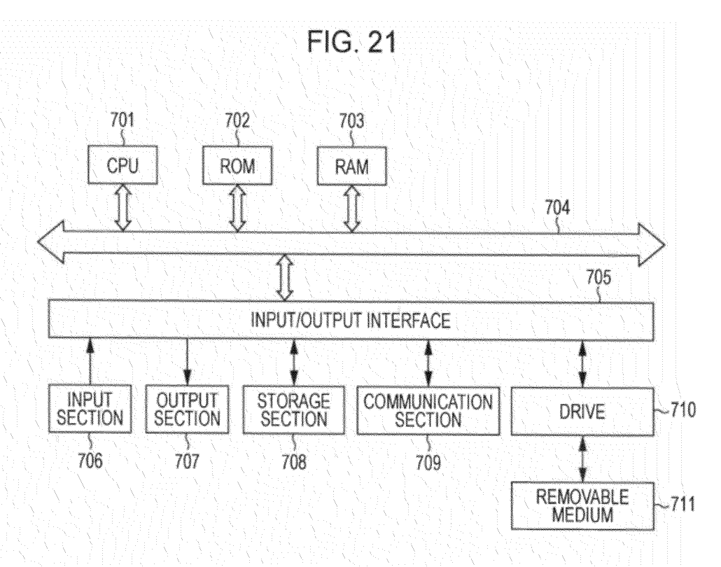

Next, a hardware configuration example of an image processing device which executes the process described above will be described with reference to FIG. 21. FIG. 21 is a block diagram describing a configuration example of an image processing device 400 according to an embodiment of the disclosure. The image processing device 400 is a device which performs a process where data is read out from a medium 410, image processing such as resolution conversion described above is executed, and an output image is generated. Specifically, the image processing device 400 is, for example, a device such as a television, a reproduction device, a video camera, a PC, or the like.

A CPU (Central Processing Unit) 701 functions as a data processing section which executes various processes in accordance with a program stored in a ROM (Read Only Memory) 702 or a storage section 708. For example, an image generating process or the like is executed which involves the resolution conversion described in each embodiment described above.

A program executed by the CPU 701, data, and the like are appropriately stored in a RAM (Random Access Memory) 703. The CPU 701, the ROM 702, and the RAM 703 are connected to each other via a bus 704.

The CPU 701 is connected to an input/output interface 705 via the bus 704, and an input section 706 formed from various types of switches, a keyboard, a mouse, a microphone, or the like, and an output device 707 formed from a display, a speaker, or the like is connected in the input/output interface 705. The CPU 701 executes various processes in correspondence with commands input from the input section 706 and outputs the results of the processing, for example, to the output section 707.

The storage section 708 which is connected to the input/output interface 705 is formed from, for example, a hard disk, and stores the program executed by the CPU 701 and various types of data. A communication section 709 communicates with an external device via a network such as the internet, a local area network, or the like.

A drive 710 which is connected to the input/output interface 705 drives a removable medium 711 such as a magnetic disc, an optical disc, a magneto optical disc, a semiconductor memory, or the like and obtains various types of data such as recorded content, programs, or the like.

Above, the disclosure has been described while referencing specific embodiments. However, it is clear to those skilled in the art that modifications and substitutions to the embodiments are possible within the scope which does not depart from the concept of the disclosure. That is, the embodiments are for the disclosing of the disclosure and are not to be interpreted as limiting. In order to determine the concept of the disclosure, the scope of the claims is to be referred to.

In addition, it is possible for the series of processes described in the specifications to be executed using hardware, software, or a configuration of a combination of both. In a case where the processes are executed using software, a program which records a process sequence is executed by being installed in a memory in a computer with built-in specialized hardware or a program is executed by being installed in a general computer which is able to execute various processes. For example, it is possible for a program to be recorded in advance on a recording medium. Other than a program being installed in a computer from a recording medium, it is possible that a program is received via a network such as a LAN (Local Area Network) or the internet and installed in a recording medium such as a built-in hard disk.

Here, various processes described in the specifications are able to be executed not only in time series in accordance with the description and may be executed in parallel or independently depending on the processing ability of the device which executes the process or as necessary. In addition, the system in the specifications is a configuration of a logical collection of a plurality of devices and is not limited to the devices of each configuration being in the same housing.

The present disclosure contains subject matter related to that disclosed in Japanese Priority Patent Application JP 2010-237883 filed in the Japan Patent Office on Oct. 22, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
a video signal output section which executes resolution conversion of an image,
wherein, in a case where a plurality of different images are included in an input image which is the resolution conversion target, the video signal output section executes a reference pixel setting process using an image edge process, which is the same as a reference pixel setting process of an image edge portion, at the time of a pixel value calculation of an output image in the vicinity of the image boundary, and a pixel value of an output pixel in the vicinity of the image boundary is determined using a pixel value of a reference pixel set using the image edge process.

2. The image processing device according to claim 1,
wherein the video signal output section sets a virtual pixel, which is generated using a pixel mirroring process in the image boundary portion of the input image, as the reference pixel at the time of the pixel value calculation of the output image in the vicinity of the image boundary.

3. The image processing device according to claim 1,
wherein the video signal output section sets a virtual pixel, which is generated using a pixel copy process in the image boundary portion of the input image, as the reference pixel at the time of the pixel value calculation of the output image in the vicinity of the image boundary.

4. The image processing device according to claim 1,
wherein the video signal output section sets a weighting coefficient according to the distance between a pixel position of the output pixel and the reference pixel and calculates the pixel value of the output pixel using the pixel value calculation of the reference pixel where the weighting coefficient has been applied at the time of the pixel value calculation of the output image in the vicinity of the image boundary.

5. The image processing device according to claim 1, further comprising:
a horizontal direction resolution conversion section which executes the setting of the pixel value of the output pixel using the image edge process at the time of the pixel value calculation of the output image in the vicinity of the image boundary in the horizontal direction of the image; and
a vertical direction resolution conversion section which executes the setting of the pixel value of the output pixel using the image edge process at the time of the pixel value calculation of the output image in the vicinity of the image boundary in the vertical direction of the image.

6. The image processing device according to claim 1,
wherein the video signal output section executes determination of whether or not there is a pixel in the vicinity of the image boundary section where it is necessary to execute the image edge process based on phase information which shows each pixel position in the output image.

7. The image processing device according to claim 1,
wherein the video signal output section executes the image edge process in the setting process of the reference pixel which is applied to the pixel value calculation of the output image in the vicinity of the image boundary of a left-eye image and a right-eye image at the time of the resolution conversion process with regard to an image with side by side format and an image with top and bottom format which are applied to three dimensional image display.

8. The image processing device according to claim 1,
wherein the video signal output section executes the resolution conversion in parallel with regard to a plurality of different pixel signals.

9. The image processing device according to claim 8,
wherein the plurality of different pixel signals are each signal of an YCbCr signal.

10. The image processing device according to claim 1,
wherein the video signal output section executes the resolution conversion, which corresponds to a plurality of display sections with different resolutions, in parallel.

11. An image display device comprising:
a video signal output section which executes resolution conversion of an image; and
a display section which displays a generated video signal of the video signal output section,
wherein, in a case where a plurality of different images are included in an input image which is the resolution conversion target, the video signal output section executes a reference pixel setting process, which is the same as a reference pixel setting process of an image edge portion, at the time of a pixel value calculation of an output image in the vicinity of the image boundary, and a pixel value of an output pixel in the vicinity of the image boundary is determined using a pixel value of a reference pixel set using the image edge process.

12. An image processing method executed by an image processing device, which includes a video signal output section which executes resolution conversion of an image, comprising:
executing a reference pixel setting process using a image edge process, which is the same as a reference pixel setting process of an image edge portion, at the time of a pixel value calculation of an output image in the vicinity of the image boundary, and determining a pixel value of an output pixel in the vicinity of the image boundary using a pixel value of a reference pixel set using the image edge process, using the video signal output section, in a case where a plurality of different images are included in an input image which is the resolution conversion target in the video signal output section.

13. A program causing an image processing device, which includes a video signal output section which executes resolution conversion of an image to execute an image process, the process comprising:
making the video signal output section execute a reference pixel setting process using an image edge process, which is the same as a reference pixel setting process of an image edge portion, at the time of a pixel value calculation of an output image in the vicinity of the image boundary, and determine a pixel value of an output pixel in the vicinity of the image boundary, in a case where a plurality of different images are included in an input image which is the resolution conversion target using a pixel value of a reference pixel set using the image edge process.
